(19) United States
(12) Patent Application Publication
(10) Pub. No.: US 2026/0244207 A1
(43) Pub. Date: Aug. 20, 2026

(54) INFORMATION PROCESSING APPARATUS, CONTROL METHOD, AND COMPUTER-READABLE RECORDING MEDIUM

(71) Applicant: NEC Corporation, Tokyo (JP)

(72) Inventor: Manao MACHIDA, Tokyo (JP)

(73) Assignee: NEC Corporation, Tokyo (JP)

(21) Appl. No.: 19/159,733

(22) PCT Filed: Mar. 1, 2023
(86) PCT No.: PCT/JP2023/007602

§ 371 Date: Aug. 26, 2025

(51) Int. Cl. G05D 1/622

(52) U.S. Cl. CPC G05D 1/622

(57) ABSTRACT

An information processing device 10 comprising: an object detection means 12 that detects the position and shape of objects 30 present in the surroundings while a moving body 20 is moving on a reference route; an obstacle assessment means 13 that assesses that an object 300 for which there is a concern of collision with the moving body 20, from among the objects 30, is an obstacle 31; an avoidance start/end point calculation means 15 that, on the basis of the distance from the obstacle 31, calculates a start point 41 and an end point 42 for an avoidance route 40 for avoiding collision with the obstacle 31; a turning path calculation means 16 that, on the basis of the distance from the obstacle 31, calculates a turning path 43 on which it is possible to turn without colliding with the obstacle 31; and an avoidance route calculation means 17 that, on the basis of a Dubins route, supplements a route 44 between the start point 41 and the turning path 43 as well as a route 44 between the turning path 43 and the end point 42 to calculate the avoidance route 40.

### TECHNICAL FIELD

The present disclosure relates to an information processing apparatus and a control method for planning a path of a mobile body, and further relates to a computer-readable recording medium recording a program for achieving the information processing apparatus and the control method.

### BACKGROUND ART

A technology for planning a path of a mobile body such as a robot is referred to as path planning or trajectory planning. The path planning includes discrete path planning and continuous path planning.

The discrete path planning divides a map into small grids, and obtains a shortest path considering movement from a grid to an adjacent grid. A graph search algorithm such as A* search algorithm is well known. NPL 1 discloses an algorithm that can develop the A* search algorithm to calculate a shortest path.

The continuous path planning includes a method for generating a path in a simulation manner in consideration of motion performance of a robot and a method using a geometric property. As a well-known method in the simulation manner, NPL 2 discloses a method for predicting a position several seconds after from a translational velocity and an angular velocity of a robot with high accuracy, and calculating a path by repeating optimization.

The method using the geometric property is a method mainly aimed at generating a path along which a robot can make a turn. NPL 3 discloses a method using a Dubins paths including only a straight line and an arc, and recently, there is a technology using curve complement connecting a plurality of points with a smooth curve, which is also used in computer graphics and the like. The path planning using the geometric property only plans a path connecting a plurality of points serving as target points, and the path planning using the geometric property alone is not used for obstacle avoidance or the like.

PTL 1 discloses a method for performing obstacle avoidance by a geometric method in combination with a discrete path planning method.

### CITATION LIST

### Patent Literature

PTL 1: JP 2021-181301 A

### Non Patent Literature

NPL 1: A. Nash, and two others, Lazy Theta*: Any-Angle Path Planning and Path Length Analysis in 3D, 2010, Proceedings of the AAAI Conference on Artificial Intelligence, 24(1), P 147-154

NPL 2: D. Fox, and two others, The dynamic window approach to collision avoidance, 1997, IEEE Robotics & Automation Magazine, volume 4, Issue 1, P23-33

NPL 3: S. Manyam, and two others, Dubins paths through a sequence of points: Lower and upper bounds, 2016, 2016 International Conference on Unmanned Aircraft Systems (ICUAS), Arlington, VA, USA, 2016, P 284-291

### SUMMARY OF INVENTION

### Technical Problem

In a case where a path that avoids an obstacle is planned, the discrete path planning or the path planning in the simulation manner is often used. In the discrete path planning, an output path may not be smooth, and a mobile body may not be able to follow the path. For example, there is a situation in which it is necessary to make a turn at a right angle in the output path, but the mobile body is not able to suddenly make a turn. Therefore, in order to plan a path that is followable and avoids an obstacle, the geometric path planning method may be used in combination.

However, the method in the simulation manner or the method obtained by combining the discrete method and the geometric method is a type of so-called optimization algorithm, and it is necessary to perform calculation for selecting an optimum candidate from a large number of candidates. As a length of the planned path becomes longer, the number of candidates for the path increases, and as a result, a calculation time becomes longer.

An example of an object of the present disclosure is to provide a mechanism capable of planning, at an earlier stage, a path that is followable and avoids an obstacle.

### Solution to Problem

In order to achieve the above object, an information processing apparatus in one aspect of the present disclosure includes
an object detection means for detecting positions and shapes of objects around a mobile body,
an obstacle determination means for determining, as an obstacle, an object on a movement path of the mobile body among the objects,
an avoidance start/end point calculation means for calculating, based on a distance from the obstacle, a start point and an end point of an avoidance path that avoids collision with the obstacle,
a turn path calculation means for calculating, based on a distance from the obstacle, a turn path on which it is possible to turn without colliding with the obstacle, and
an avoidance path calculation means for complementing, based on a Dubins path, a path between the start point and the turn path and a path between the turn path and the end point to calculate the avoidance path.

In order to achieve the above object, a control method by a computer in one aspect of the present disclosure includes
detecting positions and shapes of objects existing around while a mobile body is moving on a reference path,
determining, as an obstacle, an object that has a risk of collision with the mobile body among the objects,
calculating, based on a distance from the obstacle, a start point and an end point of an avoidance path that avoids collision with the obstacle,
calculating, based on a distance from the obstacle, a turn path on which it is possible to turn without colliding with the obstacle, and
complementing, based on a Dubins path, a path between the start point and the turn path and a path between the turn path and the end point to calculate the avoidance path.

In order to achieve the above object, a computer-readable recording medium in one aspect of the present disclosure causes a computer to
detect positions and shapes of objects existing around while a mobile body is moving on a reference path,
determine, as an obstacle, an object that has a risk of collision with the mobile body among the objects,
calculate, based on a distance from the obstacle, a start point and an end point of an avoidance path that avoids collision with the obstacle,
calculate, based on a distance from the obstacle, a turn path on which it is possible to turn without colliding with the obstacle, and
complement, based on a Dubins path, a path between the start point and the turn path and a path between the turn path and the end point to calculate the avoidance path.

### ADVANTAGEOUS EFFECTS OF INVENTION

According to the present disclosure, it is possible to plan, at an earlier stage, a path that is followable by a mobile body and avoids an obstacle.

### BRIEF DESCRIPTION OF DRAWINGS

FIG. 1 is a diagram for describing an example of an information processing apparatus in a first example embodiment.

FIG. 2 is a diagram for more specifically describing an example of the information processing apparatus in the first example embodiment.

FIG. 3 is a diagram for describing an example of a convex hull of an obstacle in the first example embodiment.

FIG. 4 is a diagram for describing an example of a start point and an end point of an avoidance path in the first example embodiment.

FIG. 5 is a diagram for describing an example of a turn path generated around the convex hull in the first example embodiment.

FIG. 6 is a diagram for describing an example of the avoidance path complemented based on a Dubins path in the first example embodiment.

FIG. 7 is a diagram for describing an example of an operation of the information processing apparatus in the first example embodiment.

FIG. 8 is a diagram for describing an example of convex hulls of a plurality of obstacles in a second example embodiment.

FIG. 9 is a diagram for describing an example of a convex hull obtained by integration in the example illustrated in FIG. 8.

FIG. 10 is a diagram for describing an example of a plurality of convex hulls including the convex hull obtained by the integration in the example illustrated in FIG. 9.

FIG. 11 is a diagram for describing an example of a convex hull obtained by further integration in the example illustrated in FIG. 10.

FIG. 12 is a diagram for describing an example of a plurality of convex hulls including the convex hull obtained by the further integration in the example illustrated in FIG. 11.

FIG. 13 is a diagram for describing an example of an avoidance path complemented based on a Dubins path in the example illustrated in FIG. 12.

FIG. 14 is a diagram for describing an example of an operation of an information processing apparatus in the second example embodiment.

FIG. 15 is a diagram for describing an example of a computer that achieves the first and second example embodiments.

### EXAMPLE EMBODIMENT

### First Example Embodiment

Hereinafter, example embodiments will be described with reference to the drawings. In the drawings described below, elements having the same function or related functions are denoted by the same reference signs, and repeated description thereof may be omitted.

### Configuration of Apparatus

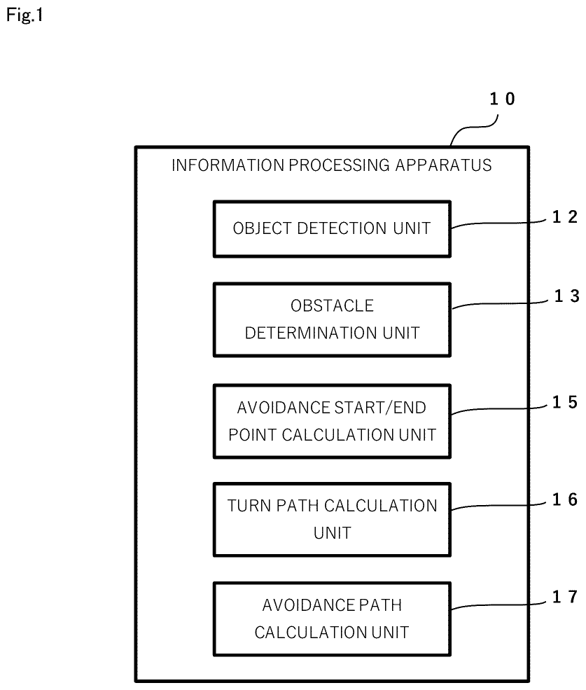

FIG. 1 is a diagram for describing an example of an information processing apparatus 10 in a first example embodiment. As illustrated in FIG. 1, the information processing apparatus 10 includes an object detection unit 12, an obstacle determination unit 13, an avoidance start/end point calculation unit 15, a turn path calculation unit 16, and an avoidance path calculation unit 17.

The object detection unit 12 detects positions and shapes of objects 30 around a mobile body 20. The object detection unit 12 functions as object detection means.

The obstacle determination unit 13 determines the object 30 on a movement path of the mobile body 20 among the objects 30 as an obstacle 31. The obstacle determination unit 13 functions as obstacle determination means.

The avoidance start/end point calculation unit 15 calculates, based on a distance from the obstacle 31, a start point 41 and an end point 42 of an avoidance path 40 that avoids collision with the obstacle 31. The avoidance start/end point calculation unit 15 functions as avoidance start/end point calculation means.

The turn path calculation unit 16 calculates, based on a distance from the obstacle 31, a turn path 43 on which it is possible to turn without colliding with the obstacle 31. The turn path calculation unit 16 functions as turn path calculation means.

The avoidance path calculation unit 17 calculates, based on a Dubins path, the avoidance path 40 by complementing a path 44 between the start point 41 and the turn path 43 and a path 45 between the turn path 43 and the end point 42. The avoidance path calculation unit 17 functions as avoidance path calculation means.

In the first example embodiment, since only a geometric method that can perform calculation at high speed without performing exploratory calculation is used, a path that is followable and avoids an obstacle can be planned at an earlier stage.

Examples of the mobile body 20 include a movable robot, an automatic guided vehicle, a self-driving vehicle, a self-flying vehicle, and a self-sailing ship.

The information processing apparatus 10 in the first example embodiment may include the object detection unit 12 that detects the positions and the shapes of the objects 30 around the mobile body 20, the obstacle determination unit 13 that specifies the certain obstacle 31 on the movement path of the mobile body 20 among the objects 30, the avoidance start/end point calculation unit 15 that calculates, based on the distance from the obstacle 31, the start point 41 and the end point 42 of the avoidance path 40 that avoids the obstacle 31 in the movement path, the turn path calculation unit 16 that calculates the turn path 43 separated from the obstacle 31 by the certain distance, and the avoidance path calculation unit 17 that calculates the avoidance path 40 from the start point 41 to the end point 42 via the turn path 43.

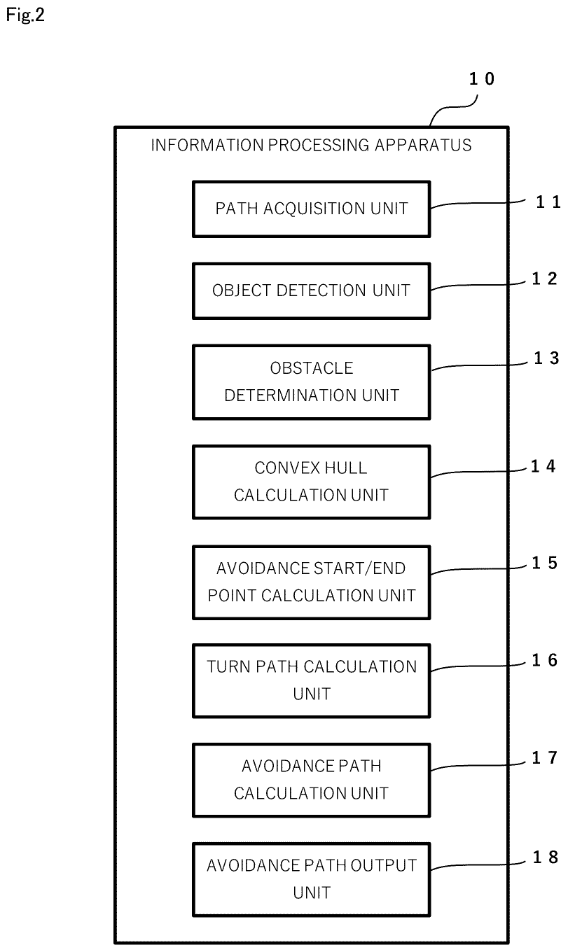

FIG. 2 is a diagram for more specifically describing an example of the information processing apparatus in the first example embodiment. As illustrated in FIG. 2, the information processing apparatus 10 may further include a path acquisition unit 11, a convex hull calculation unit 14, and an avoidance path output unit 18. Hereinafter, a configuration and a function of information processing in the first example embodiment will be specifically described.

The path acquisition unit 11 receives and acquires an input of a path (reference path) of the mobile body 20 scheduled in advance. The reference path is, for example, a path determined before departure or the like. The reference path is a path created from information such as a known terrain, but not all pieces of terrain information is reflected. Therefore, in a case where the mobile body moves along the path, the mobile body may collide with an unknown obstacle.

The object detection unit 12 specifically detects the positions and the shapes of the objects 30 around the mobile body 20 by an ultrasonic sensor, an infrared sensor, or the like. A detectable distance is determined for each sensor, and the object 30 can be detected only when the mobile body 20 approaches within a certain distance from the object 30. That is, the objects 30 are detected while the mobile body 20 is moving along the reference path. In many cases, detection results of the sensor are given as a point cloud (a collection of a plurality of points).

The obstacle determination unit 13 specifically determines whether there is a risk of collision with the objects 30 detected by the object detection unit 12 when the mobile body 20 moves along the reference path. A method for determining whether there is the risk of collision is not limited. A representative determination method is a method for comparing a distance between nearest points of the reference path and the object 30 with a preset threshold. When the distance between the nearest points is equal to or less than the threshold, it is determined that there is the risk of collision. In a case where the obstacle determination unit 13 determines that there is no risk of collision between the mobile body 20 moving on the reference path and the object 30, it is not necessary to change the reference path, and thus the processing is ended here. On the other hand, in a case where the obstacle determination unit 13 determines that there is the risk of collision, the processing proceeds to planning of the avoidance path that avoids the collision.

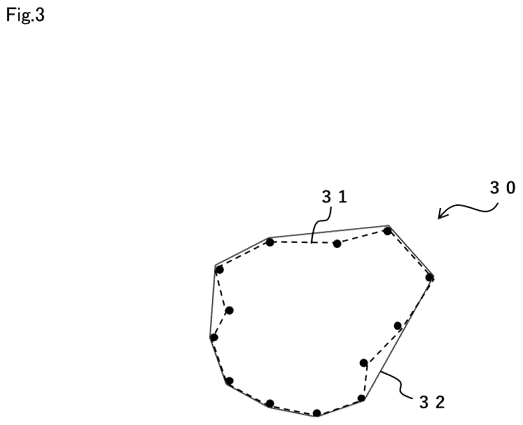

The convex hull calculation unit 14 calculates, as preliminary preparation for planning a collision avoidance path, a convex hull 32 of the obstacle 31 determined to have the risk of collision among the objects 30. FIG. 3 is a diagram for describing an example of the convex hull of the obstacle 31. As illustrated in FIG. 3, the convex hull 32 of the obstacle 31 given as a point cloud is a minimum convex set including the obstacle. The convex hull 32 can be created in an optional figure, but in the present specification, a case will be considered where the convex hull 32 is a convex polygon. The convex hull 32 as the point cloud is always the convex polygon.

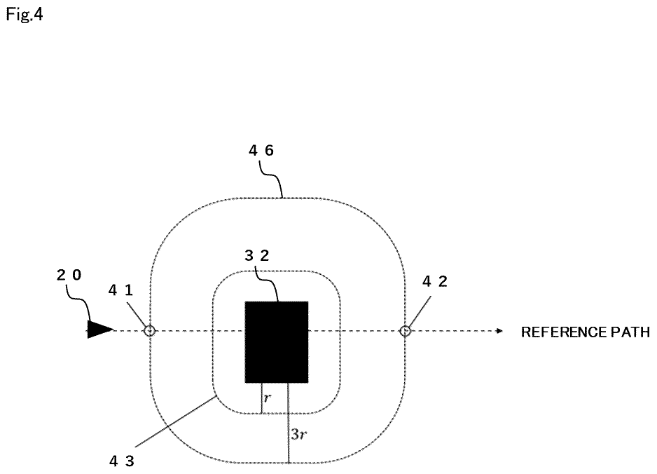

The avoidance start/end point calculation unit 15 calculates the start point 41 and the end point 42 of the avoidance path 40 from the convex hull 32 calculated by the convex hull calculation unit 14 and the reference path acquired by the path acquisition unit 11. FIG. 4 is a diagram for describing an example of the start point 41 and the end point 42 of the avoidance path 40 in the first example embodiment. The avoidance path 40 in the present disclosure starts to branch off the reference path at the start point 41, and ends to join the reference path at the end point 42. More specifically, a first pseudo enlarged view 46 of the convex hull 32 separated by an optional distance around the convex hull 32 is assumed. For example, when a distance equal to or more than a minimum turning radius of the mobile body 20 is set as r, the first pseudo enlarged view 46 is generated in such a way that a nearest distance becomes 3r. A point at which the reference path intersects first with the first pseudo enlarged view 46 is set as the start point 41, and a point at which the reference path intersects last with the first pseudo enlarged view 46 is set as the end point 42. In the example of FIG. 3, an example is indicated in which the first pseudo enlarged view 46 is generated based on 3r, but the first pseudo enlarged view 46 may be generated in such a way that the nearest distance becomes 2r. The first pseudo enlarged view 46 is not necessarily have to be an enlarged view, and is only required to have a shape including at least the convex hull 32.

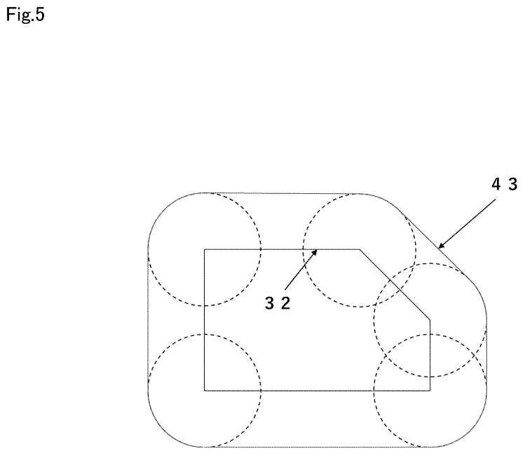

The turn path calculation unit 16 specifically calculates a path for turning around the obstacle 31. Specifically, a path obtained by enlarging the convex hull 32 by the preset distance r is calculated. FIG. 5 is a diagram for describing an example of the turn path 43 generated around the convex hull 32 in the first example embodiment. As illustrated in FIG. 5, a second pseudo enlarged view of the convex hull 32 separated by the optional distance r around the convex hull 32 is assumed, and this is set as the turn path 43. In the example illustrated in FIG. 5, in a case where the convex hull 32 is the convex polygon, when circles each having a radius of the preset value r with each vertex of the convex polygon as a center are arranged, the convex hull of all the circles become the turn path 43. The turn path 43 is the Dubins path including only straight lines and arcs.

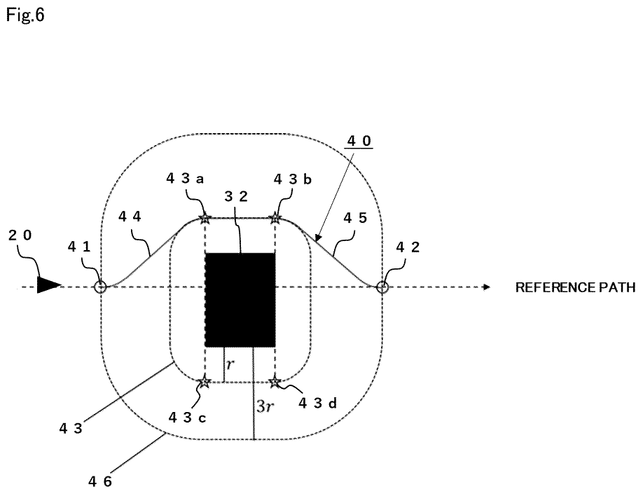

FIG. 6 is a diagram for describing an example of the avoidance path complemented based on the Dubins path in the first example embodiment. As illustrated in FIG. 6, the avoidance path calculation unit 17 calculates, based on the Dubins path, the avoidance path 40 by complementing the path 44 between the start point 41 and the turn path 43 and the path 45 between the turn path 43 and the end point 42. In FIG. 6, Dubins complement is performed on the start point 41 to the clockwise turn path 43 and the clockwise turn path 43 to the end point 42 to generate the avoidance path 40. The avoidance path 40 is the Dubins path.

The Dubins path is a path including only a combination of a straight line and an arc having a certain radius, and when the radius of the arc is set to be equal to or more than the minimum turning radius of the mobile body 20, the mobile body 20 can turn (can make a turn) in the path. In general, the Dubins path can be generated in such a way as to connect two points having directions. That is, it is possible to generate the path on which the mobile body that starts moving from a certain direction at a certain point ends moving in such a way as to have a direction at a certain point.

More specifically, the avoidance path calculation unit 17 generates a Dubins path connecting the start point 41 of the avoidance path 40 to an optional point of the turn path 43. When the convex hull 32 of the obstacle 31 is the convex polygon, intersections 43a and 43c between the turn path 43 and a straight line obtained by extending an intersecting side on a side of the convex polygon when the reference path and the convex polygon intersect for the first time are set as candidates for points connected to the start point 41 of the avoidance path 40.

Next, a Dubins path connecting an optional point of the turn path 43 to the end point of the avoidance path 40 is generated. When the convex hull 32 of the obstacle 31 is the convex polygon, intersections 43b and 43d between the turn path 43 and a straight line obtained by extending an intersecting side on the side of the convex polygon when the reference path and the convex polygon intersect last are set as candidates for points connected to the end point 42 of the avoidance path 40.

In FIG. 6, when the start point 41 and the end point 42 of the avoidance path 40 are calculated based on the first pseudo enlarged view 46 obtained by enlarging the convex hull 32 by three times the turning radius, the two avoidance paths 40 including the clockwise avoidance path 40 and the counterclockwise avoidance path 40 can be generated. In a case where calculation is performed based on the first pseudo enlarged view obtained by enlarging the turning radius by twice, there is a possibility that either one cannot be generated, that is, there is a possibility that the path subjected to the Dubins complement collides with the obstacle.

In a case where the clockwise avoidance path 40 is generated, the path is complemented in such a way as to connect the start point 41 and the point 43a on the turn path 43 and connect the point 43b on the turn path 43 and the end point 42. In contrast, in a case where the counterclockwise avoidance path is generated, the path is complemented in such a way as to connect the start point 41 and the point 43c on the turn path 43 and connect the point 43c on the turn path 43 and the end point 42. In a case where the shorter avoidance path 40 is calculated, both the clockwise and counterclockwise paths may be calculated, and the shorter path may be calculated as the avoidance path 40.

The avoidance path output unit 18 outputs the avoidance path 40 calculated by the turn path calculation unit 16. The avoidance path 40 output here is always the Dubins path since the avoidance path 40 connects the turn path 43 as the Dubins path and the start point 41 and the end point 42 by the Dubins path. That is, since the radius of the arc of the avoidance path 40 is equal to or more than the minimum turning radius of the mobile body 20, the avoidance path 40 is the path on which the mobile body 20 can turn, that is, can make a turn.

### Operation of Apparatus

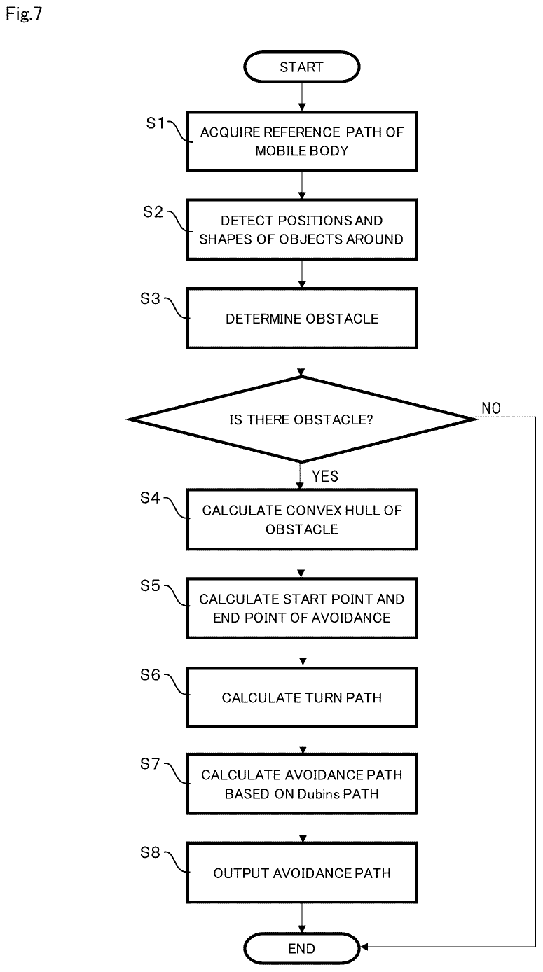

Next, an operation of the information processing apparatus 10 in the first example embodiment will be described. FIG. 7 is a flowchart illustrating the operation of the information processing apparatus in the first example embodiment. In the following description, FIGS. 1 to 6 will be appropriately referred to. In the first example embodiment, a control method is performed by operating the information processing apparatus. Therefore, description of the control method in the example embodiment is replaced with the following description of the operation of the information processing apparatus.

As illustrated in FIG. 7, first, the path acquisition unit 11 receives and acquires the input of the path (reference path) of the mobile body 20 scheduled in advance (step S1)

The object detection unit 12 detects the positions and the shapes of the objects 30 existing around while the mobile body 20 is moving on the reference path (step S2).

The obstacle determination unit 13 determines the object 30 that has the risk of collision with the mobile body 20 as the obstacle 31 among the objects 30 (step S3).

In a case where there is no object 30 determined as the obstacle 31 (NO), it is not necessary to change the reference path, and thus the operation is ended. In a case where there is the object 30 determined as the obstacle 31 (YES), the processing proceeds to step S4 described below.

The convex hull calculation unit 14 calculates the convex hull 32 of the obstacle 31 determined to have the risk of the collision among the objects 30 as the preliminary preparation for planning the collision avoidance path (step S4).

The avoidance start/end point calculation unit 15 calculates, based on the distance from the obstacle 31, the start point 41 and the end point 42 of the avoidance path 40 that avoids the collision with the obstacle 31 (step S5).

Next, the turn path calculation unit 16 calculates, based on the distance from the obstacle 31, the turn path 43 on which it is possible to turn without colliding with the obstacle 31. The turn path calculation unit 16 functions as the turn path calculation means (step S6).

The avoidance path calculation unit 17 calculates, based on the Dubins path, the avoidance path 40 by complementing the path 44 between the start point 41 and the turn path 43 and the path 45 between the turn path 43 and the end point 42 (step S7).

The avoidance path output unit 18 outputs the avoidance path 40 calculated by the turn path calculation unit 16 (step S7).

### Program

The program in the first example embodiment is only required to be a program that causes a computer to execute steps S1 to S8 illustrated in FIG. 7. When the program is installed in the computer and executed, the information processing apparatus and the control method in the first example embodiment can be achieved. In this case, a processor of the computer functions as the path acquisition unit 11, the object detection unit 12, the obstacle determination unit 13, the convex hull calculation unit 14, the avoidance start/end point calculation unit 15, the turn path calculation unit 16, the avoidance path calculation unit 17, and the avoidance path output unit 18, and performs the processing.

The program in the first example embodiment may be executed by a computer system constructed by a plurality of computers. In this case, for example, each computer may function as any one of the path acquisition unit 11, the object detection unit 12, the obstacle determination unit 13, the convex hull calculation unit 14, the avoidance start/end point calculation unit 15, the turn path calculation unit 16, the avoidance path calculation unit 17, and the avoidance path output unit 18.

### Second Example Embodiment

Next, an information processing apparatus 10 in a second example embodiment will be described with reference to the drawings.

### Configuration of Apparatus

The first example embodiment provides the mechanism for calculating the path that avoids the one obstacle 31. A basic configuration and function of the information processing apparatus of the second example embodiment are similar to those of the information processing apparatus of the first example embodiment. The second example embodiment relates to a case where an object detection unit 12 detects a plurality of objects 30, and further an obstacle determination unit 13 determines that there is an obstacle 31 that has a possibility of collision among the plurality of objects 30. In this case, information regarding a plurality of the obstacles 31 is transmitted to a convex hull calculation unit 14. Hereinafter, a configuration and a function of the convex hull calculation unit 14 that has received such information will be described.

The following two procedures are roughly performed.

1) Among the objects, obstacles that have a risk of collision with a mobile body moving on a reference path are listed. Convex hulls of these obstacles are calculated, and for each convex hull, the same view as a first pseudo enlarged view of a convex hull calculated by an avoidance path start/end point calculation unit 15 is generated.

2) Presence or absence of contact between the first pseudo enlarged views and contact with another object is confirmed, and in a case where the contact is present, the convex hulls are integrated into one convex hull to form one obstacle.

Hereinafter, specific description will be given with reference to the drawings.

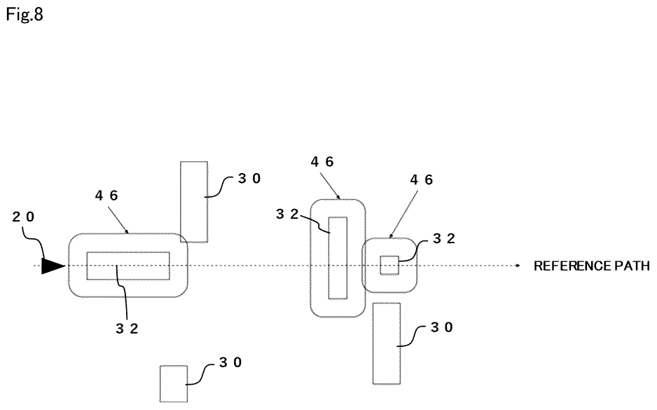

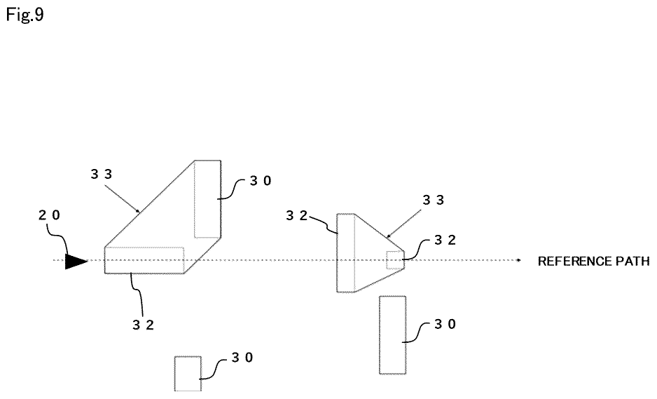

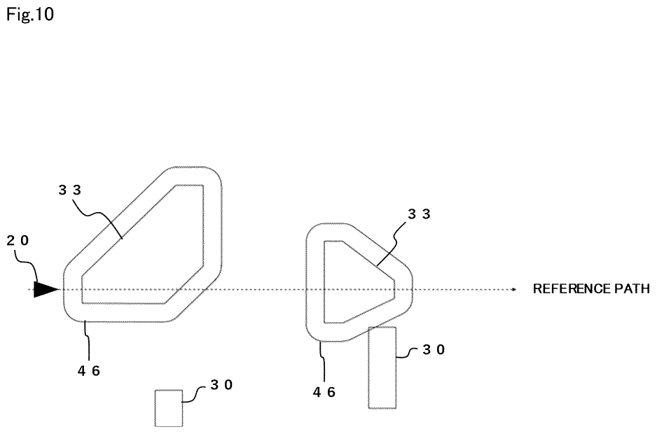

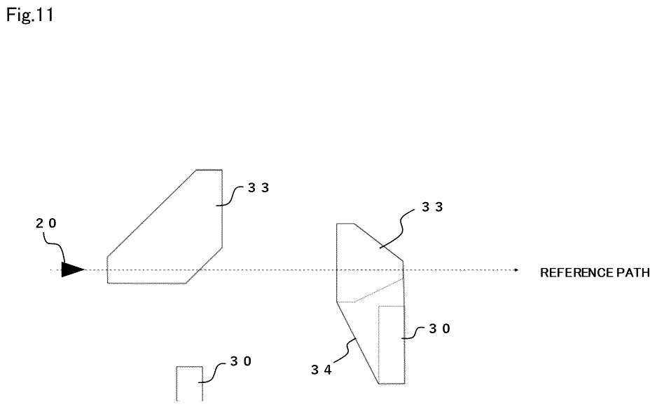

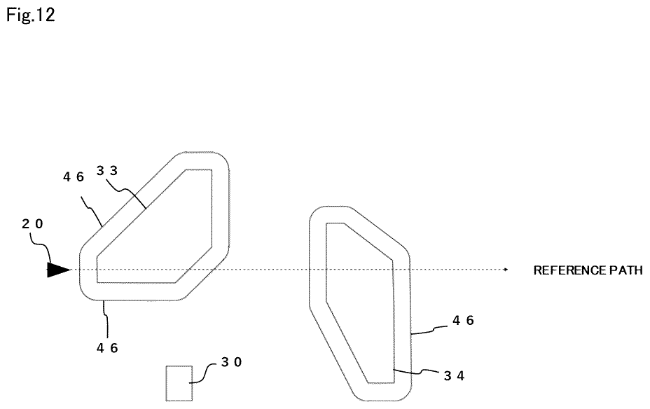

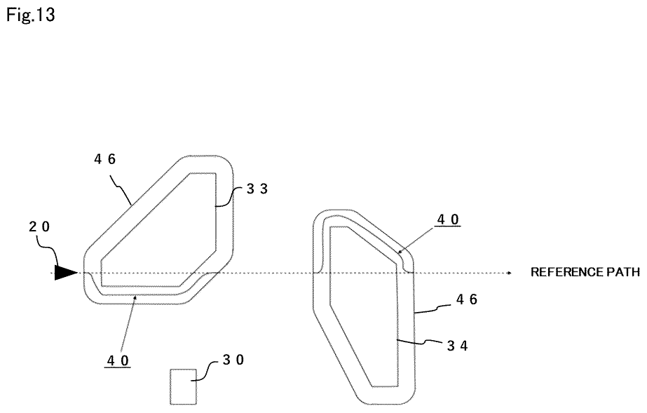

FIG. 8 is a diagram for describing an example of the convex hulls of the plurality of obstacles in the second example embodiment. FIG. 9 is a diagram for describing an example of a convex hull obtained by integration in the example illustrated in FIG. 8. FIG. 10 is a diagram for describing an example of a plurality of convex hulls including the convex hull obtained by the integration in the example illustrated in FIG. 9. FIG. 11 is a diagram for describing an example of a convex hull obtained by further integration in the example illustrated in FIG. 10. FIG. 12 is a diagram for describing an example of a plurality of convex hulls including the convex hull obtained by the further integration in the example illustrated in FIG. 11. FIG. 13 is a diagram for describing an example of an avoidance path complemented based on a Dubins path in the example illustrated in FIG. 12.

As illustrated in FIG. 8, the convex hull calculation unit 14 divides the plurality of transmitted objects 30 into objects for which it is necessary to consider an avoidance path 40 and objects for which it is not necessary to consider the avoidance path 40, and calculates the convex hull 32 for each of all the obstacles 31 for which it is necessary to consider the avoidance path 40. The example of FIG. 8 illustrates a case where there are the three convex hulls 32 of the obstacle determined to have the risk of the collision and there are the two other objects 30. It is then confirmed whether there is a first pseudo enlarged view 46 of another convex hull 32 or another object 30 that comes into contact with a first pseudo enlarged view 46 generated for the convex hull 32.

As illustrated in FIG. 9, in a case where there is the first pseudo enlarged view 46 of the another convex hull 32 or the another object 30 that is in contact with the first pseudo enlarged view 46 generated for the convex hull 32, the obstacles are integrated to obtain a new convex hull 33. The above operation is repeated, that is, as illustrated in FIG. 10, the first pseudo enlarged view 46 is generated again for the new convex hull 33, and it is confirmed whether there is the first pseudo enlarged view 46 of the another convex hull 32 or 33 or the another object 30 that comes into contact with such a first pseudo enlarged view 46.

As illustrated in FIG. 11, in a case where there is the first pseudo enlarged view 46 of the another convex hull 32 or 33 or the another object 30 that is in contact with the first pseudo enlarged view 46 generated for the convex hull 33, the obstacles are integrated to obtain a new convex hull 34. As illustrated in FIG. 12, the first pseudo enlarged view 46 is generated again for the new convex hull 34, and it is confirmed whether there is the first pseudo enlarged view 46 of the another convex hull 32, 33, or 34 or the another object 30 that comes into contact with such a first pseudo enlarged view 46. The first pseudo enlarged view 46 is generated again for the new convex hull 34, and in a case where there is no first pseudo enlarged view 46 of the another convex hull 32, 33, or 34 or the another object 30 that comes into contact with such a first pseudo enlarged view 46, this processing is ended.

The convex hull calculation unit 14 sequentially transmits the convex hulls 32, 33, and 34 of the obstacles 31 that collide with a mobile body 20 moving on the reference path. The avoidance start/end point calculation unit 15, a turn path calculation unit 16, and an avoidance path calculation unit 17 perform processing similar to that in the first example embodiment on the convex hull 32 for the one obstacle 31 and the convex hulls 33 and 34 calculated based on the plurality of obstacles 31.

As illustrated in FIG. 13, since the avoidance path 40 is always generated between the first pseudo enlarged view 46 and the original obstacle 31, the avoidance path 40 and the other obstacle 31 do not collide with each other. Therefore, by integrating and dividing the obstacles 31 in this manner even in a case where there is the plurality of obstacles 31, it is possible to calculate the avoidance path 40 that avoids all the obstacles 31.

According to the second example embodiment, since only a geometric method that can perform calculation at high speed without performing exploratory calculation is used even in a case where there is the plurality of obstacles, a path that is followable and avoids the obstacles can be planned at an earlier stage.

### Operation of Apparatus

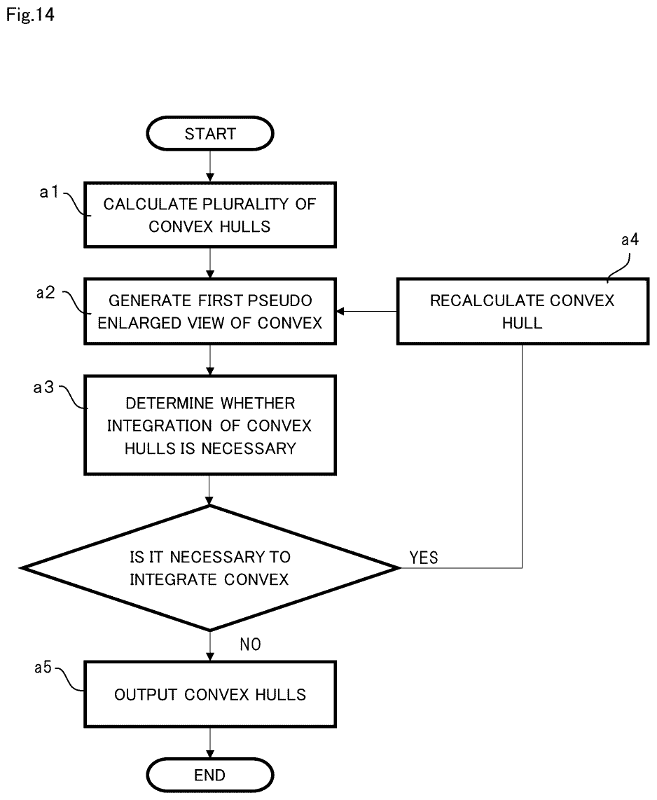

Next, an operation of the convex hull calculation unit 14 of the information processing apparatus in the second example embodiment will be described. FIG. 14 is a diagram for describing an example of the operation of the information processing apparatus in the second example embodiment.

As illustrated in FIG. 14, first, the convex hull calculation unit 14 divides the plurality of transmitted objects 30 into the objects for which it is necessary to consider the avoidance path 40 and the objects for which it is not necessary to consider the avoidance path 40, and calculates the convex hull 32 for each of all the obstacles 31 for which it is necessary to consider the avoidance path 40 (step al).

Next, for each convex hull 32, the same view as the first pseudo enlarged view 46 of the convex hull calculated by the avoidance path start/end point calculation unit 15 is generated (step a2).

It is confirmed whether there is the first pseudo enlarged view 46 of the another convex hull 32 or the another object 30 that comes into contact with the generated first pseudo enlarged view 46 (step a3). In a case where there is the corresponding convex hull 32 (YES), the convex hull 33 is newly generated (step a4), and the first pseudo enlarged view 46 is generated for the newly generated convex hull (step a2). On the other hand, in a case where there is no such a convex hull 32 (NO), the processing is ended.

The convex hull calculation unit 14 sequentially outputs the convex hulls 32, 33, and 34 of the obstacles 31 that collide with the mobile body 20 moving on the reference path (step a5).

### Program

A program in the second example embodiment is only required to be a program that causes a computer to execute steps a1 to a5 illustrated in FIG. 14. When the program is installed in the computer and executed, the information processing apparatus and a control method in the second example embodiment can be achieved. In this case, a processor of the computer functions as a path acquisition unit 11, the object detection unit 12, the obstacle determination unit 13, the convex hull calculation unit 14, the avoidance start/end point calculation unit 15, the turn path calculation unit 16, the avoidance path calculation unit 17, and an avoidance path output unit 18, and performs the processing.

The program in the second example embodiment may be executed by a computer system constructed by a plurality of computers. In this case, for example, each computer may function as any one of the path acquisition unit 11, the object detection unit 12, the obstacle determination unit 13, the convex hull calculation unit 14, the avoidance start/end point calculation unit 15, the turn path calculation unit 16, the avoidance path calculation unit 17, and the avoidance path output unit 18.

### Physical Configuration

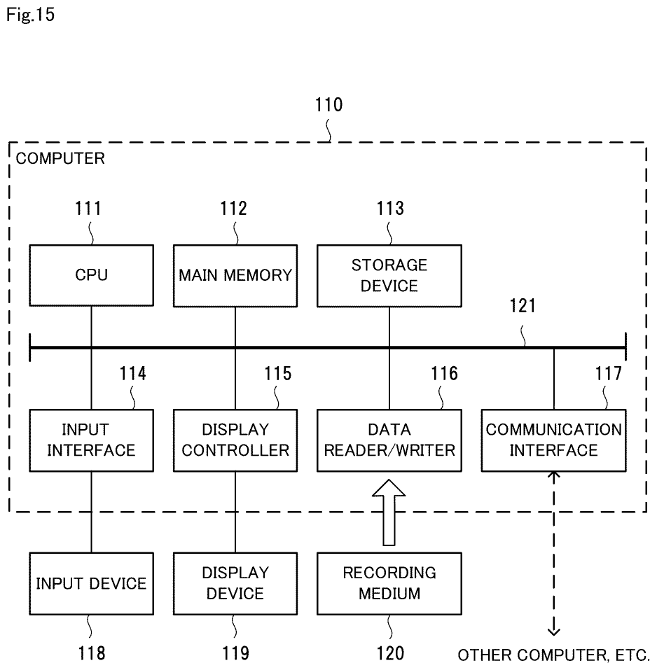

Here, the computer that achieves the information processing apparatus by executing the program in the first and second example embodiments will be described with reference to FIG. 15. FIG. 15 is a block diagram illustrating an example of the computer that achieves the information processing apparatus in the first and second example embodiments.

As illustrated in FIG. 15, a computer 110 includes a central processing unit (CPU) 111, a main memory 112, a storage device 113, an input interface 114, a display controller 115, a data reader/writer 116, and a communication interface 117. These units are connected via a bus 121 in such a way as to be able to perform data communication with each other.

The computer 110 may include a graphics processing unit (GPU) or a field-programmable gate array (FPGA) in addition to the CPU 111 or instead of the CPU 111. In this mode, the GPU or the FPGA can execute the program in the example embodiments.

The CPU 111 develops the program in the example embodiments, which is stored in the storage device 113 and includes codes, in the main memory 112, and executes the codes in a predetermined order to perform various operations. The main memory 112 is typically a volatile storage device such as a dynamic random access memory (DRAM).

The program in the example embodiments is provided in a state of being stored in a computer-readable recording medium 120. The program in the present example embodiments may be distributed on the Internet connected via the communication interface 117.

Specific examples of the storage device 113 include a semiconductor storage device such as a flash memory in addition to a hard disk drive. The input interface 114 mediates data transmission between the CPU 111 and input devices 118 such as a keyboard and a mouse. The display controller 115 is connected to a display device 119 and controls display on the display device 119.

The data reader/writer 116 mediates data transmission between the CPU 111 and the recording medium 120, and reads the program from the recording medium 120 and writes a processing result in the computer 110 to the recording medium 120. The communication interface 117 mediates data transmission between the CPU 111 and another computer.

Specific examples of the recording medium 120 include general-purpose semiconductor storage devices such as a compact flash (CF) (registered trademark) and secure digital (SD), a magnetic recording medium such as a flexible disk, and an optical recording medium such as a compact disk read only memory (CD-ROM).

The information processing apparatus 10 in the example embodiment can also be achieved by using hardware related to each unit, for example, an electronic circuit, instead of the computer in which the program is installed. A part of the information processing apparatus 10 may be achieved by a program, and the remaining part may be achieved by hardware. In the example embodiments, the computer is not limited to the computer illustrated in FIG. 15.

Some or all of the above-described example embodiments can be expressed by (Supplementary Note 1) to (Supplementary Note 13) described below, but are not limited to the following description.

### Supplementary Note 1

An information processing apparatus including:
an object detection means for detecting positions and shapes of objects existing around while a mobile body is moving on a reference path;
an obstacle determination means for determining, as an obstacle, an object that has a risk of collision with the mobile body among the objects;
an avoidance start/end point calculation means for calculating, based on a distance from the obstacle, a start point and an end point of an avoidance path that avoids collision with the obstacle;
a turn path calculation means for calculating, based on a distance from the obstacle, a turn path on which it is possible to turn without colliding with the obstacle; and
an avoidance path calculation means for complementing, based on a Dubins path, a path between the start point and the turn path and a path between the turn path and the end point to calculate the avoidance path.

### Supplementary Note 2

The information processing apparatus according to Supplementary Note 1, further including
a convex hull calculation means for calculating a convex hull of the obstacle, in which the avoidance start/end point calculation means generates a first pseudo enlarged view separated by an optional distance around the convex hull, and calculates the start point and the end point based on intersections between the first pseudo enlarged view and the reference path.

### Supplementary Note 3

The information processing apparatus according to Supplementary Note 2, in which
the turn path calculation unit calculates the turn path along a second pseudo enlarged view smaller than the first pseudo enlarged view and separated by an optional distance around the convex hull.

### Supplementary Note 4

The information processing apparatus according to Supplementary Note 2, in which
the convex hull calculation means calculates the convex hull by regarding a plurality of adjacent obstacles as one obstacle.

### Supplementary Note 5

A control method by a computer, the control method including:
detecting positions and shapes of objects existing around while a mobile body is moving on a reference path;
determining, as an obstacle, an object that has a risk of collision with the mobile body among the objects;
calculating, based on a distance from the obstacle, a start point and an end point of an avoidance path that avoids collision with the obstacle;
calculating, based on a distance from the obstacle, a turn path on which it is possible to turn without colliding with the obstacle; and
complementing, based on a Dubins path, a path between the start point and the turn path and a path between the turn path and the end point to calculate the avoidance path.

### Supplementary Note 6

The control method according to Supplementary Note 5, further including:
calculating a convex hull of the obstacle; and
generating a first pseudo enlarged view separated by an optional distance around the convex hull, and calculating the start point and the end point based on intersections between the first pseudo enlarged view and the reference path.

### Supplementary Note 7

The control method according to Supplementary Note 6, in which the turn path is calculated along a second pseudo enlarged view smaller than the first pseudo enlarged view and separated by an optional distance around the convex hull.

### Supplementary Note 8

The control method according to Supplementary Note 5, in which the convex hull is calculated by regarding a plurality of adjacent obstacles as one obstacle.

### Supplementary Note 9

A computer-readable recording medium recording a program including an instruction for causing a computer to:
detect positions and shapes of objects existing around while a mobile body is moving on a reference path;
determine, as an obstacle, an object that has a risk of collision with the mobile body among the objects;
calculate, based on a distance from the obstacle, a start point and an end point of an avoidance path that avoids collision with the obstacle;
calculate, based on a distance from the obstacle, a turn path on which it is possible to turn without colliding with the obstacle; and
complement, based on a Dubins path, a path between the start point and the turn path and a path between the turn path and the end point to calculate the avoidance path.

### Supplementary Note 10

The computer-readable recording medium according to Supplementary Note 9, further causing the computer to:
calculate a convex hull of the obstacle; and
generate a first pseudo enlarged view separated by an optional distance around the convex hull, and calculate the start point and the end point based on intersections between the first pseudo enlarged view and the reference path.

### Supplementary Note 11

The computer-readable recording medium according to Supplementary Note 10, further causing the computer to
calculate the turn path along a second pseudo enlarged view smaller than the first pseudo enlarged view and separated by an optional distance around the convex hull.

### Supplementary Note 12

The computer-readable recording medium according to Supplementary Note 9, further causing the computer to
calculate the convex hull by regarding a plurality of adjacent obstacles as one obstacle.

### Supplementary Note 13

An information processing apparatus including:
an object detection means for detecting positions and shapes of objects around a mobile body;
an obstacle determination means for specifying an obstacle on a movement path of the mobile body among the objects;
an avoidance start/end point calculation means for calculating, based on a distance from the obstacle, a start point and an end point of an avoidance path that avoids the obstacle in the movement path;
a turn path calculation means for calculating a turn path separated from the obstacle by a certain distance; and
an avoidance path calculation means for calculating the avoidance path from the start point to the end point via the turn path.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

### INDUSTRIAL APPLICABILITY

According to the present disclosure, it is possible to plan, at an earlier stage, a path on which a mobile body avoids an obstacle.

### REFERENCE SIGNS LIST

information processing apparatus
11 path acquisition unit
12 object detection unit
13 obstacle determination unit
14 convex hull calculation unit
15 avoidance start/end point calculation unit
16 turn path calculation unit
17 avoidance path calculation unit
18 avoidance path output unit
20 mobile body
30 object
31 obstacle
32, 33, 34 convex hull
40 avoidance path
41 start point
42 end point
43 turn path (second pseudo enlarged view)
43a, 43b, 43c, 43d intersection
44, 45 path
46 first pseudo enlarged view
110 computer
111 CPU
112 main memory
113 storage device
114 input interface
115 display controller
116 data reader/writer
117 communication interface
118 input device
119 display device
120 recording medium
121 bus

What is claimed is:

1. An information processing apparatus comprising:
at least one memory storing instructions; and
at least one processor configured to execute the instructions to:
detect positions and shapes of objects around a mobile body;
determine, as an obstacle, an object that is on a movement path of the mobile body among the objects;
calculate, based on a distance from the obstacle, a start point and an end point of an avoidance path that avoids collision with the obstacle;
calculate, based on a distance from the obstacle, a turn path on which it is possible to turn without colliding with the obstacle; and
complement, based on a Dubins path, a path between the start point and the turn path and a path between the turn path and the end point to calculate the avoidance path.

2. The information processing apparatus according to claim 1, wherein
the one or more processors further:
calculates a convex hull of the obstacle,
generates a first pseudo enlarged view separated by an optional distance around the convex hull, and calculates the start point and the end point based on intersections between the first pseudo enlarged view and the reference path.

3. The information processing apparatus according to claim 2, wherein
the one or more processors further:
calculates the turn path along an enlarged view of the convex hull.

4. The information processing apparatus according to claim 2, wherein
the one or more processors further:
calculates the convex hull by regarding a plurality of adjacent obstacles as one obstacle.

5. A control method by a computer, the control method comprising:
detecting positions and shapes of objects existing around while a mobile body is moving on a reference path;
determining that an object that has a risk of collision with the mobile body among the objects is an obstacle;
calculating, based on a distance from the obstacle, a start point and an end point of an avoidance path that avoids collision with the obstacle;
calculating, based on a distance from the obstacle, a turn path on which it is possible to turn without colliding with the obstacle; and
complementing, based on a Dubins path, a path between the start point and the turn path and a path between the turn path and the end point to calculate the avoidance path.

6. The control method according to claim 5, further comprising:
calculating a convex hull of the obstacle; and
generating a first pseudo enlarged view separated by an optional distance around the convex hull, and calculating the start point and the end point based on intersections between the first pseudo enlarged view and the reference path.

7. The control method according to claim 6, wherein
the turn path is calculated along a second pseudo enlarged view smaller than the first pseudo enlarged view and separated by an optional distance around the convex hull.

8. The control method according to claim 6, wherein
the convex hull is calculated by regarding a plurality of adjacent obstacles as one obstacle.

9. A non-transitory computer-readable recording medium recording a program including an instruction for causing a computer to:
detect positions and shapes of objects existing around while a mobile body is moving on a reference path;
determine, as an obstacle, an object that has a risk of collision with the mobile body among the objects;
calculate, based on a distance from the obstacle, a start point and an end point of an avoidance path that avoids collision with the obstacle;
calculate, based on a distance from the obstacle, a turn path on which it is possible to turn without colliding with the obstacle; and
complement, based on a Dubins path, a path between the start point and the turn path and a path between the turn path and the end point to calculate the avoidance path.

10. The non-transitory computer-readable recording medium according to claim 9, further causing the computer to:
calculate a convex hull of the obstacle; and
generate a first pseudo enlarged view separated by an optional distance around the convex hull, and calculate the start point and the end point based on intersections between the first pseudo enlarged view and the reference path.

11. The non-transitory computer-readable recording medium according to claim 10, further causing the computer to
calculate the turn path along a second pseudo enlarged view smaller than the first pseudo enlarged view and separated by an optional distance around the convex hull.

12. The non-transitory computer-readable recording medium according to claim 10, further causing the computer to
calculate the convex hull by regarding a plurality of adjacent obstacles as one obstacle.

13. (Canceled)
